(19) United States
(12) Patent Application Publication
(10) Pub. No.: US 2014/0045378 A1
(43) Pub. Date: Feb. 13, 2014

(54) Electrical Connector Assembly and Housing

(71) Applicant: Tyco Electronics Japan G.K., Kanagawa-ken (JP)

(72) Inventor: Shoji Kawashima, Kanagawa (JP)

(73) Assignee: Tyco Electronics Japan G.K., Kanagawa-ken (JP)

(21) Appl. No.: 13/963,742

(22) Filed: Aug. 9, 2013

(30) Foreign Application Priority Data
Aug. 9, 2012 (JP) 2012-176731

(51) Int. Cl. H01R 13/648

(52) U.S. Cl. CPC H01R 13/648
USPC 439/607.58

(57) ABSTRACT

An electrical connector assembly that includes a housing having a shield receiving space, a retainer receiving opening, and a retainer support disposed along a terminal edge surface of the retainer receiving opening and extending into the retainer receiving opening. The housing includes a shield positioned in the shield receiving space, and a retainer positioned in the retainer receiving opening.

### CROSS-REFERENCE TO RELATED APPLICATION

This application claims the benefit of the filing date under 35 U.S.C. §119(a)-(d) of Japanese Patent Application No. 2012-176731, filed Aug. 9, 2012.

### FIELD OF THE INVENTION

The present invention generally relates to an electrical connector, and more specifically to an electrical connector including a retainer that retains a shield member of the electrical connector in a connector housing.

### BACKGROUND

Traditionally, an electrical connector (hereinafter referred to as a “connector”) uses a retainer to ensure or enhance locking of a shield to a connector housing. Japanese Patent No. 9-129307 illustrates a traditional connector, where the shield shieldhouses a terminal fitting, and the shield is held in the housing by the retainer.

Assembly of the traditional connector is performed by placing the retainer in the housing in an intermediate locking position, before the shield is inserted into a shield accommodating space in the housing. Then, the retainer is moved to a final locking position to lock the shield, thereby holding the shield in the housing.

Using the traditional assembly method, the retainer assembled in the intermediate locking position is pressed into the housing and moved to the final locking position. During conveyance of the connector, the retainer can accidentally be pressed to the final locking position, preventing the shield from being inserted into the housing. An extra operation is then required to return the retainer to the intermediate locking position, and the operational efficiency is greatly reduced.

### SUMMARY

It is therefore an object of the invention to provide an electrical connector assembly that prevents a retainer assembled to a housing from being accidentally moved from an intermediate locking position to a final locking position, while also reducing the number of steps needed to place the retainer in the final locking position.

An electrical connector assembly according to the invention includes a housing having a shield receiving space, a retainer receiving opening, and a retainer support disposed along a terminal edge surface of the retainer receiving opening and extending into the retainer receiving opening. The housing includes a shield positioned in the shield receiving space, and a retainer positioned in the retainer receiving opening.

### DESCRIPTION OF THE DRAWINGS

FIG. 1 is a perspective view of an electrical connector assembly in which a retainer is held in a final locking position;

FIG. 2 is a perspective view showing the electrical connector assembly with the retainer removed;

FIG. 3A is a bottom view of the retainer;

FIG. 3B is a top view of the retainer;

FIG. 4 is a bottom view showing the shield in contrast with the retainer;

FIG. 5 is a perspective view of an electrical connector assembly with the retainer being held in a intermediate locking position;

FIGS. 6A and 6B correspondingly show a connector housing in which the retainer is held in the intermediate locking position and the shield before insertion,

FIG. 6A is a perspective view of the electrical connector assembly from a side in which the retainer is held in the intermediate locking position and the shield before insertion;

FIG. 6B is a sectional view, taken along the line 6b-6b in FIG. 6A, of the electrical connector assembly from the top, in which the retainer is held in the intermediate locking position and the shield before insertion;

FIG. 7A is a side view of the electrical connector assembly in which the shield is inserted into the connector housing, and the retainer is held in the final locking position; and

FIG. 7B is a sectional view taken along the line 7b-7b in FIG. 7A of the electrical connector assembly in which the shield is inserted into the connector housing, and the retainer is held in the final locking position.

### DETAILED DESCRIPTION OF THE EMBODIMENTS

Now, the invention will be described in detail based on an embodiment shown in the accompanying drawings.

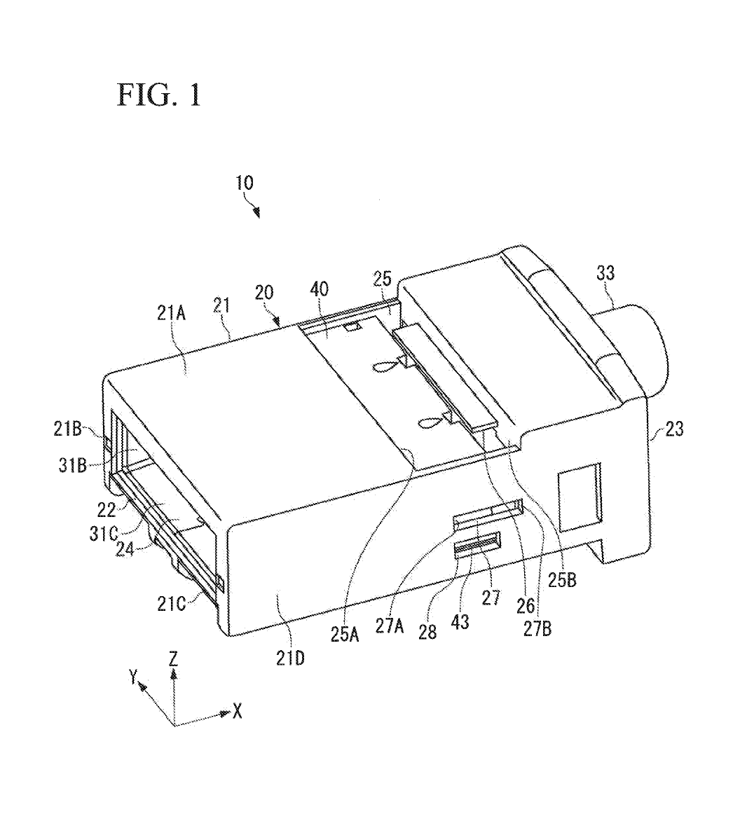

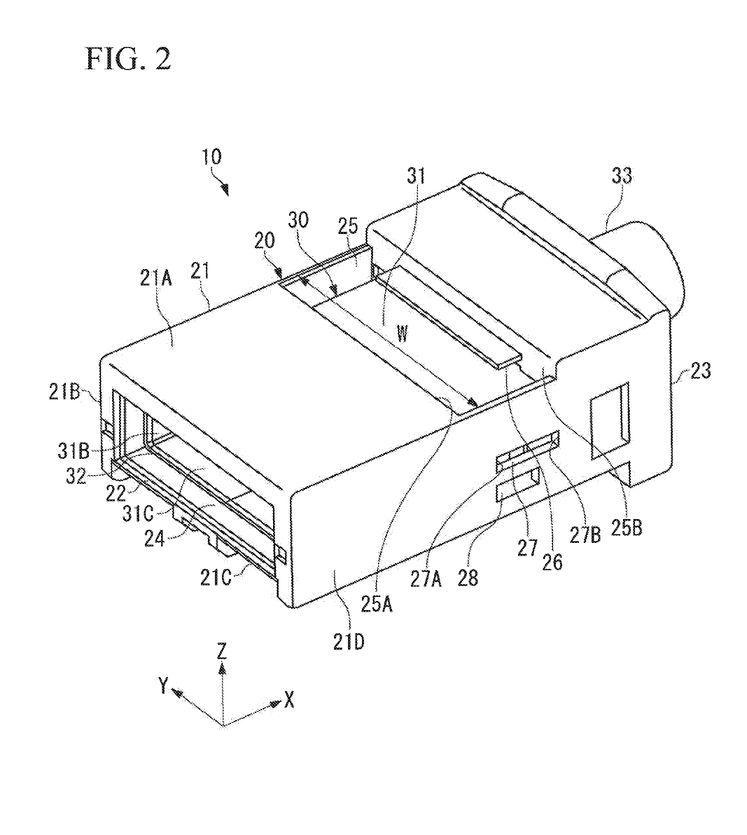

As shown in FIGS. 1 and 2 of this embodiment, an electrical connector assembly 10 includes a housing 20, a shield 30 positioned in the housing 20, and a retainer 40 that is secured in the housing 20 in a final locking position and thus prevents the shield 30 from being removed from the housing 20.

The housing 20 in which the retainer 40 is held in a intermediate locking position and the shield 30, which are separated from each other, are conveyed from respective manufacturers to a user who incorporates the housing 20 and the shield 30 into a device. The user inserts the shield 30 into the housing 20, then presses the retainer 40 in a direction perpendicular to an insertion direction of the shield 30, which moves the retainer 40 from the intermediate locking position to the final locking position. In this embodiment, the retainer 40 is prevented from being accidentally moved to the final locking position before the shield 30 is inserted into the housing 20, thereby preventing the need for an additional operation to be performed to return the retainer 40 to the intermediate locking position so the shield 30 can be inserted into the housing 20.

The housing 20 includes a body 21 formed by injection molding of insulating resin, a first opening 22 positioned on a mating end of the body 21 that receives a corresponding connector (not shown), a second opening 23 positioned on a terminal end opposite the first opening 22 along the longitudinal direction and into which the shield 30 is inserted, and a shield receiving space 24 extending through the first opening 22 and the second opening 23. The shield 30 is inserted through the second opening 23 into the housing 20, and housed and held in the housing 20 in a predetermined position in the shield receiving space 24.

The body 21 includes an upper wall 21A and an opposing lower wall 21C, and a first side wall 21B and an opposing second sidewall 21D. The first side wall 21B and the second sidewall 21D are disposed along longitudinal edges of the upper wall 21A and lower wall 21C and connect the longitudinal edges of the upper wall 21A with the longitudinal edges of the lower wall. The first side wall 21B is disposed along a first longitudinal edge of the first sidewall 21B and a first longitudinal edge of the second sidewall 21D. The second sidewall 21D is disposed along a second longitudinal edge of the first sidewall 21B and a second longitudinal edge of the second sidewall 21D. The heights of the first side wall 21B and the second sidewall 21D are equal in a axial direction Z, and the heights are greater than the height of the shield 30.

A retainer receiving opening 25 is positioned on the upper wall 21A. In an embodiment, the retainer receiving opening 25 is rectangular. In another embodiment, the retainer receiving space is square. The retainer receiving opening 25 extends through the upper wall 21A and provides communication between the shield receiving space 24 and an outside. The retainer receiving opening 25 has a first edge 25A which is located closer to the first opening 22 and the mating end, and a second edge 25B, which is located closer to the second opening 23 and the terminal end. A retainer support 26 is disposed along the second edge 25B and protrudes toward the first edge 25A.

The retainer receiving opening 25 has a distance in the longitudinal direction X being larger than a length of the retainer 40, and a distance in the width direction Y being larger than a width W of the retainer 40. Therefore, the size of retainer receiving opening 25 is such that the retainer 40 can pass through the retainer receiving opening 25.

When the retainer 40 has been inserted into the retainer receiving opening 25 and is in the intermediate locking position, the retainer contacts the retainer support 26 that protrudes from the second edge 25B. The retainer support 26 prevents the retainer 40 from being further inserted through the retainer receiving opening 25. To further insert the retainer 40 into the retainer receiving opening 25 and into the final locking position, the retainer 40 can be moved in the longitudinal direction X towards the mating end of the body until the retainer 40 no longer contacts the retainer support 26.

In this embodiment, the retainer support 26 is a rectangular flat plate, although in other embodiments the retainer support 26 can be a flat plate of a different shape, for example, a triangular or trapezoidal flat plate, or may include a plurality of cylindrical protrusions along the second edge 25B as long as the retainer support 26 can serve to support the retainer in the intermediate locking position.

The retainer 40 is secured in the retainer receiving opening 25 by the body 21. In the final locking position, the retainer 40 prevents the shield 30 from being removed out of the housing 20. As described above, the retainer 40 is first located in the intermediate locking position, and then moved to the final locking position when the shield 30 is fully inserted into the shield receiving space 24. In FIG. 1, the retainer 40 is in the final locking position and retains the shield 30.

The first and second side walls 21B, 21D each have a first lock receiving slot 27 and a second lock receiving slot 28. The first lock receiving slot 27 and the second lock receiving slot 28 are rectangular holes extending through the side walls 21B, 21D. The first lock receiving slot 27 is disposed on the first and second sidewalls 21B, 21D closer to the upper wall 21A than the second on lock receiving slot 28, and the second lock receiving slot 28 is disposed on the first and second sidewalls 21B, 21D closer to the lower wall 21C.

When the retainer 40 is in the intermediate locking position, a lock 43 of the retainer 40 is inserted into the first lock receiving slot 27 to hold the retainer 40. The first lock receiving slot 27 has a length along the longitudinal direction X considerably larger than the length of the lock 43. The retainer 40 can be moved in the longitudinal direction X by a difference between the length of first lock receiving slot 27 and the length of lock 43 when the lock 43 is engaged in the first lock receiving slot 27.

The first lock receiving slot 27 has a first slot edge 27A closer to the first opening 22 and a second slot edge 27B closer to the second opening 23. When the retainer 40 is in the intermediate locking position, the lock 43 abuts against the second slot edge 27B. To move the retainer 40 to the final locking position from the intermediate locking position, the lock 43 is moved along the longitudinal direction X towards the first opening 22 until the lock 43 abuts against the first slot edge 27A. As such, the first lock receiving slot 27 serves as a guide to move the retainer 40 from the intermediate locking position to a final locking preparation position, and ensures stable movement of the retainer 40.

When the retainer 40 is in the final locking position, the lock 43 of the retainer 40 is inserted into the second lock receiving slot 28 and holds the retainer 40 in the body 21. The second lock receiving slot 28 has a length in the longitudinal direction X equal to the length of the lock 43. When the lock 43 is inserted into the second lock receiving slot 28, movement of the retainer 40 along the longitudinal direction X is restricted.

The first slot edge 27A and a receiving end edge of the second lock receiving slot 28 are aligned in the axial direction Z, so the retainer 40 can be pressed inward to move the lock 43 from the first lock receiving slot 27 to the second lock receiving slot 28. To accomplish this step, the retainer 40 is moved from the intermediate locking position to the final locking preparation position, and then pressed and moved to the final locking position.

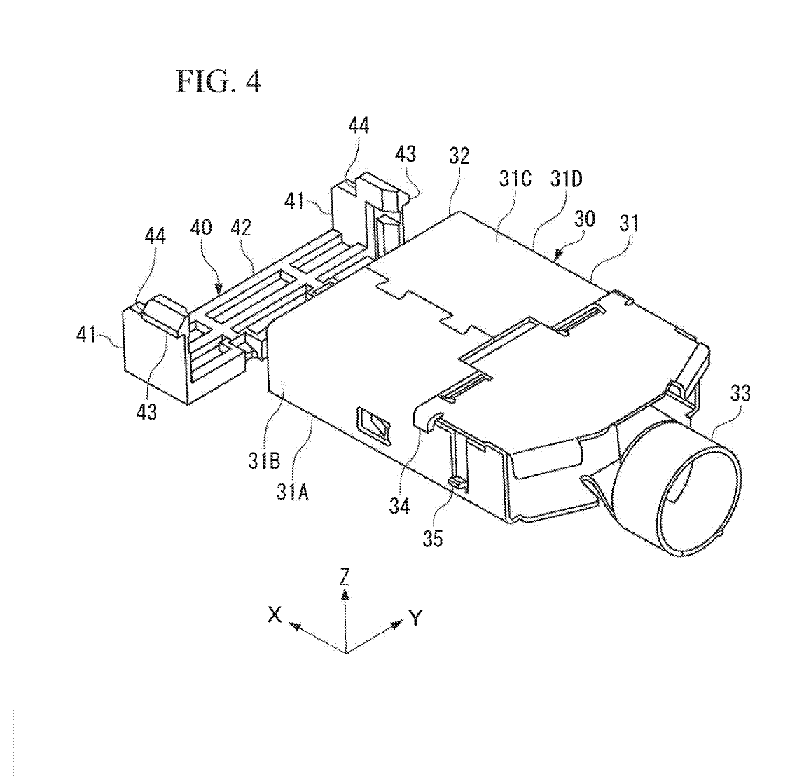

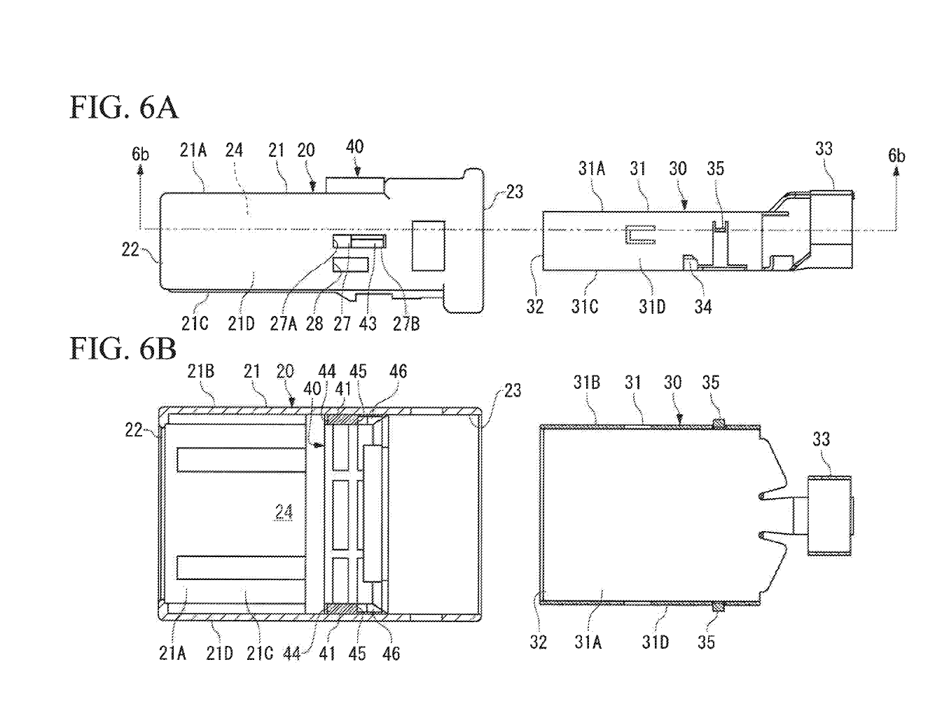

As shown in FIGS. 4, 6A and 6B, the shield 30 includes a shield housing 31 that houses a plurality of terminal fittings (not shown) and a plurality of wires connected to the terminal fittings, a shield mating end 32 with which a counterpart connector mates, and a wire terminal 33 through which the plurality of wires are drawn. The shield 30 is inserted from the shield mating end 32 into the shield receiving space 24 of the housing 20. The shield 30 is formed by punching and folding a metal plate.

The shield housing 31 includes a shield upper wall 31A and an opposing shield lower wall 31C, and a first shield side wall 31B and an opposing second shield side wall 31D The first shield side wall 31B and the second shield sidewall 31D are disposed along longitudinal edges of the shield upper wall 31A and shield lower wall 31C and connect the longitudinal edges of the shield upper wall 31A with the longitudinal edges of the shield lower wall 31C. The first shield side wall 31B is disposed along a first longitudinal edge of the first shield side wall 31B and a first longitudinal edge of the second shield side wall 31D. The second shield side wall 31D is disposed along a second longitudinal edge of the first shield side wall 31B and a second longitudinal edge of the second shield side wall 31D. The heights of the first shield side wall 31B and the second shield side wall 21D are equal in a axial direction Z, and the heights are less than the height of the shield receiving space 24 of the housing 20. A pair of shield securing members 34 project outward and overhang at an interface between the shield lower wall 31C and the first shield side wall 31 B, and at an interface between the shield lower wall 31 C and the second shield side wall 31D. A load transfer member 35 projects outward and overhangs from a portion of the first shield side wall 31B closer to the shield upper wall 31A, while another load transfer member 35 projects outward and overhangs from a portion of the second shield side wall 31D closer to the shield upper wall 31A. The shield securing member 34 is locked to the retainer 40 in the final locking position to retain the shield 30 with respect to the housing 20. When the shield 30 is inserted into the housing 20, the load transfer member 35 contacts the retainer 40 when the retainer 40 is in the intermediate locking position and as the shield 30 is further inserted in the to housing 20, the load transfer member 35 pushes against and moves the retainer 40 to the final locking preparation position.

The shield securing member 34 and the load transfer member 35 are both formed by punching and folding in a process of manufacturing the shield 30.

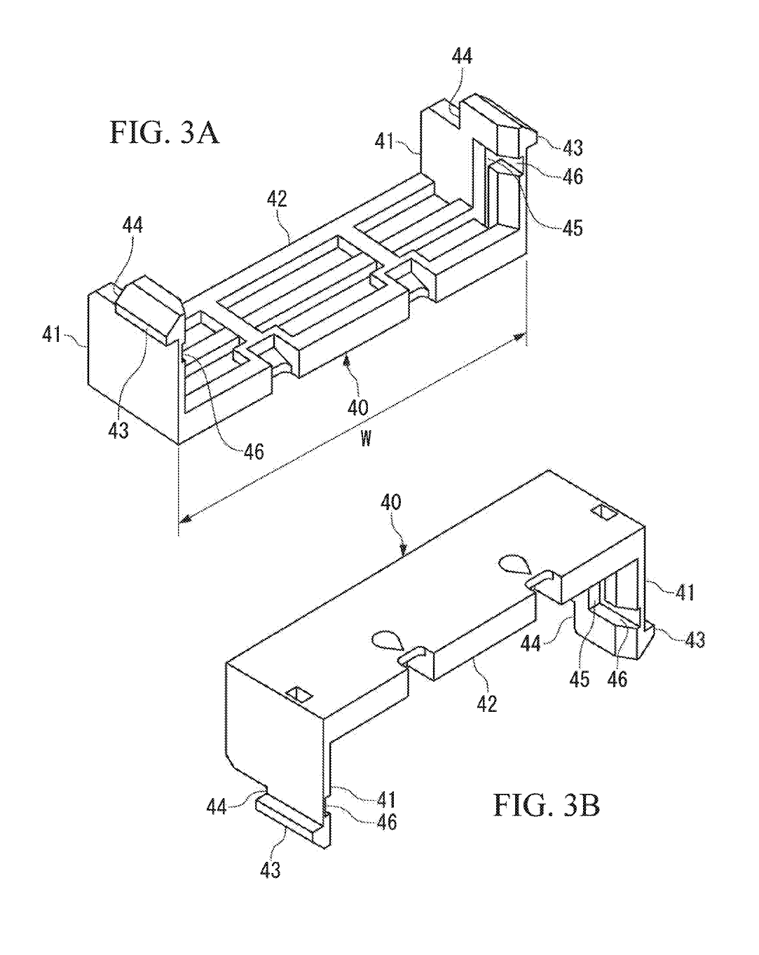

The retainer 40 is formed by injection molding of insulating resin or other suitable insulating material, and as illustrated in FIGS. 3A and 3B, includes a bridge 42 and a pair of lock arms 41 projecting from opposing ends of the bridge 42. The pair of lock arms 41 project in the same direction as each other, and orthogonally from the longitudinal axis of the bridge 42.

A lock 43 protruding outward along the longitudinal axis of the bridge 42 is formed at an end of each lock arm 41. When the retainer 40 is in the intermediate locking position, each of the locks 43 are inserted into the first lock receiving slot 27 and locked to the body 21. When the retainer 40 is in the final locking position, the lock 43 is inserted into the second lock receiving slot 28 and locked to the body 21. One side surface of the lock 43 forms a final locking surface 44 to which the shield securing member 34 is locked when the retainer 40 is in the final locking position. On an inner surface of the lock arm 41, a load receiving surface 45 to which a load from the load transfer member 35 of the shield 30 is applied when the shield 30 is inserted into the housing 20 is formed at a back of a load transfer member passageway 46. The load transfer member 35 passes through the load transfer member passageway 46 and abuts against the load receiving surface 45, then the load transfer member 35 presses and moves the retainer 40 to the final locking preparation position.

The retainer 40 includes the pair of lock arms 41, but a retainer 40 including any one of the lock arms 41 can retain the shield 30.

In this embodiment, the retainer 40 includes the lock 43, and the housing 20 includes the first lock receiving slot 27 and the second lock receiving slot 28. However, the retainer 40 may include parts corresponding to the first lock receiving slot 27 and the second lock receiving slot 28, and the housing 20 may include a part corresponding to the lock 43.

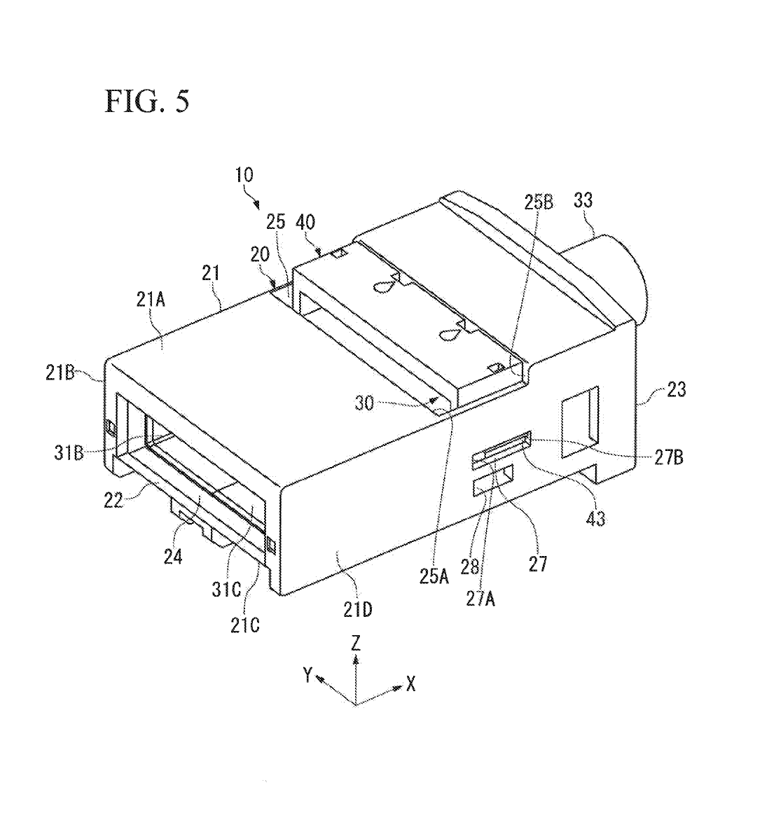

Next, with reference to FIGS. 5 to 7A,7B, an assembling procedure of the assembly 10 will be described.

As shown in FIGS. 5, 6A and 6B, the retainer 40 is inserted into the retainer receiving opening 25 of the housing 20 and held in the intermediate locking position. When in the intermediate locking position, the lock 43 of each lock arm 41 is inserted into each of the first lock receiving slot 27 of the housing 20. The retainer 40 is adjacent to the second edge 25B of the retainer receiving opening 25, while an interior surface of the bridge 42 is supported by the retainer support 26. Thus, the retainer support 26 prevents the retainer 40 from being pressed in the housing 20 into the final locking position. However, the movement along the longitudinal direction X of the retainer 40 toward the first edge 25A is allowed as described above.

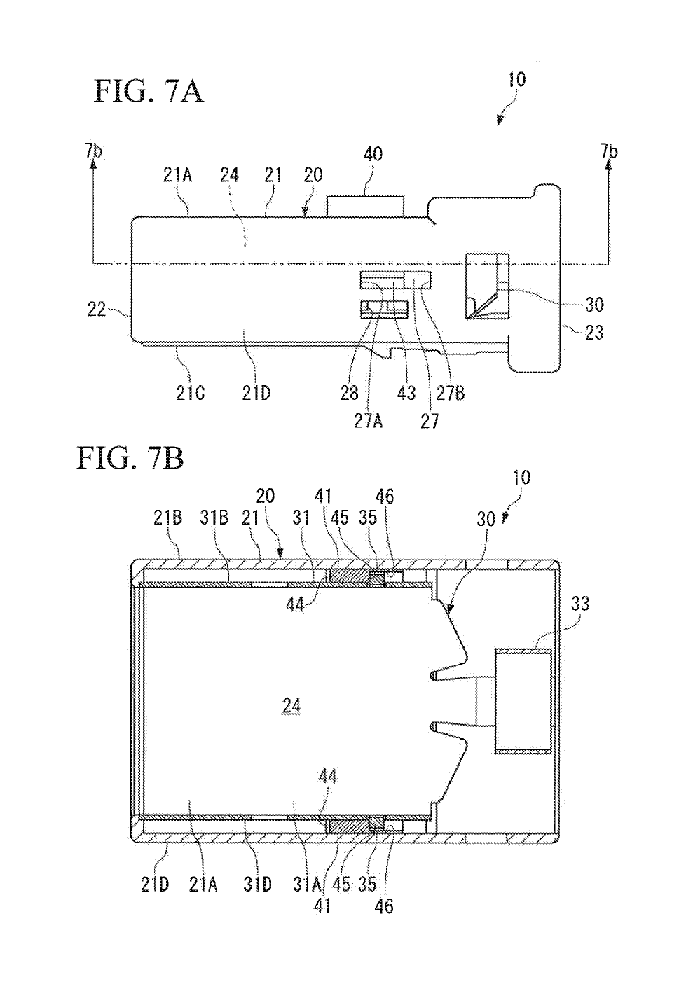

The shield 30 is inserted by the shield mating end 32 through the second opening 23 into the shield receiving space 24 of the body 21. As the shield 30 is displaced along the longitudinal axis of the housing 20 toward the mating end of the shield receiving space 24 (side of the first opening 22), the load transfer member 35 abuts against the load receiving surface 45. When the shield 30 is further displaced towards the mating end of the shield receiving space 24, the load transfer member 35 pushes against the load receiving surface 45 resulting in the retainer 40 also being displaced towards the mating end of the shield receiving space 24. When the shield 30 is fully inserted into the shield receiving space 24, as shown in FIGS. 7A and 7B, the retainer 40 will have been displaced from the intermediate locking position to the final locking preparation position, and the bridge 42 is no longer supported by the retainer support 26. At this time, each of the lock 43 of the retainer 40 is still inserted into the first lock receiving slot 27 of the body 21. In this embodiment, the load transfer member 35 and the load receiving surface 45 are provided to identify parts to which a load is applied from the shield 30 to the retainer 40, thereby ensuring transfer of the load from the shield 30 to the retainer 40.

When the retainer 40 is pressed inward into the housing 20 from the final locking preparation position to the final locking position, each of the locks 43 of the retainer 40 is released from the first lock receiving slot 27 and then inserted into the second lock receiving slot 28. The retainer 40 is then in the final locking position, and assembling of the assembly 10 is finished as shown in FIG. 1. Therefore, in the final locking position, each of the shield securing members 34 of the shield 30 is locked to the final locking surface 44 (exterior facing surface of the lock 43) of the retainer 40, and, each of the locks 43 is inserted into the second lock receiving slot 28 of the housing 20. As a result, movement of the retainer 40 along the longitudinal direction X is restricted, and the shield 30 is retained with respect to the second opening 23.

As described above, the assembly 10 of this embodiment includes the retainer support 26 that supports the retainer 40 in the intermediate locking position in the housing 20, thereby eliminating the risk that the retainer 40 is accidentally pressed inward into the final locking position. Thus, according to the assembly 10, there is no need for an extra operation to return the retainer 40 to the intermediate locking position.

In the assembly 10, the act of inserting the shield 30 into the shield receiving space 24 releases the retainer 40 from the support provided by the retainer support 26, and moves the retainer 40 in the intermediate locking position to the final locking preparation position. Thus, as compared to separately performing an operation of moving the retainer 40 from the intermediate locking position to the final locking preparation position, an assembling operation of the assembly 10 requires only two steps: 1. insertion of the shield 30, and 2. movement of the retainer 40 from the final locking preparation position to the final locking position, result in high efficiency.

Although the above embodiments show and describe the assembly 10 as an example, one of ordinary skill in the art would appreciate that changes or modifications may be made without departing from the principles and spirit of the disclosure, the scope of which is defined in the claims and their equivalents.

For example, the retainer 40 for retaining the shield 30 has been described, but the present invention may be applied to a different element constituting an electrical connector, for example, a member referred to as an inner housing or the like, or a connector including a retainer for retaining a terminal fitting. Also in this case, it may be sufficient that a support body that supports a retainer in a intermediate locking position is provided, and with an operation of inserting the member, support by the support body is released, and the retainer in the intermediate locking position is moved to a final locking preparation position.

In another embodiment, one of ordinary skill in the art would appreciate that the body 21 can be formed from any suitable insulating material.

In this embodiment, the shield securing member 34 and the load transfer member 35 provided in the shield 30 are formed by cutting in the axial direction Z, but not limited to this, may be formed by cutting in the longitudinal direction X. However, forming the shield securing members or load transfer members in the direction in this embodiment increases rigidity in the insertion direction of the shield 30, which is advantageous for retaining the shield 30, and pressing the shield 30 from the intermediate locking position to the final locking preparation position.

In this embodiment, the retainer 40 in the final locking position is placed without a gap from the first edge 25A of the retainer receiving opening 25, but there may be a gap in this position. However, the size of gap can be adjusted in size to minimize entry of foreign matters into the assembly 10.

What is claimed is:

1. An electrical connector assembly comprising:
a housing having a shield receiving space, a retainer receiving opening, and a retainer support disposed along a terminal edge surface of the retainer receiving opening and extending into the retainer receiving opening;
a shield positioned in the shield receiving space; and
a retainer positioned in the retainer receiving opening and supported on the retainer support in an intermediate locking position.

2. The electrical connector assembly according to claim 1, wherein the retainer is displaceable towards a mating end of the retainer receiving opening by the shield.

3. The electrical connector assembly according to claim 2, wherein the displaced retainer is released from contact with the retainer support.

4. The electrical connector assembly according to claim 2, wherein the retainer is displaceable from contact with the retainer support in an intermediate locking position by a load from the shield.

5. The electrical connector assembly according to claim 2, wherein the retainer includes a load receiving surface, and
the shield includes a load transfer member contactable with the load receiving surface.

6. The electrical connector assembly according to claim 1, wherein the housing includes a first lock receiving slot and a second lock receiving slot.

7. The electrical connector assembly according to claim 6, wherein the retainer includes a lock engageable with the first lock receiving slot when in the intermediate locking position and engageable with the second lock receiving slot when in a final locking position.

8. The electrical connector assembly according to claim 2, wherein:
the housing further includes a first lock receiving slot and a second lock receiving slot, and
the retainer includes a lock engageable with the first lock receiving slot when in the intermediate locking position and engageable with the second lock receiving slot when in a final locking position.

9. The electrical connector assembly according to claim 8, wherein the retainer is displaceable when the lock is engaged with the first lock receiving slot.

10. An electrical connector assembly comprising:
a housing having a shield receiving space, a retainer receiving opening, and a retainer support disposed along a terminal edge surface of the retainer receiving opening and extending into the retainer receiving opening;
a shield positioned in the shield receiving space; and
a retainer positioned in the retainer receiving opening.

11. The electrical connector assembly according to claim 10, wherein the housing includes a first lock receiving slot and a second lock receiving slot.

12. The electrical connector assembly according to claim 11, wherein the first lock receiving slot is positioned at an approximate midsection of a housing sidewall and the second lock receiving slot is positioned on the housing sidewall at a distance further from the retainer receiving opening than the position of the first lock receiving slot.

13. The electrical connector assembly according to claim 12, wherein the retainer includes a lock engageable with the first lock receiving slot when in an intermediate locking position and engageable with the second lock receiving slot when in a final locking position.

14. The electrical connector assembly according to claim 13, wherein the shield is locked in the shield receiving space when the lock is engaged with the second lock receiving slot.
